(19) United States
(12) Patent Application Publication
(10) Pub. No.: US 2010/0280152 A1
(43) Pub. Date: Nov. 4, 2010

(54) Thermoformable and RF Sealable Plastic Packaging Material

(75) Inventor: Phillip S. Barhouse, Oshkosh, WI (US)

Correspondence Address: Patent Docket Department;Armstrong Teasdale LLP, 7700 Forsyth Boulevard, Suite 1800, St. Louis, MO, 63105, US

(73) Assignee: Spartech Corporation, St. Louis, MO (US)

(21) Appl. No.: 12/432,034

(22) Filed: Apr. 29, 2009

(51) Int. Cl. C08L 67/00; C08F 8/46; B29C 47/00; B32B 37/30

(52) U.S. Cl. 523/523; 525/386; 264/176.1; 264/210.1; 156/275.1

(57) ABSTRACT

A thermoformable packaging material, in an exemplary embodiment, includes a thermoplastic composition that includes a polyethylene terephthalate modified with an isophthalic acid co-monomer. The amount of isophthalic acid co-monomer used is sufficient to render the thermoplastic composition RF sealable.

### BACKGROUND OF THE DISCLOSURE

The field of the disclosure relates generally to thermoplastic packaging materials, and more specifically to a radio frequency (RF) sealable or heat sealable thermoplastic packaging material.

In the consumer packaging field, RF sealing is used to weld two halves of a package together. The sealed package provides protection and theft deterrence. RF sealing uses high frequency electromagnetic energy to generate heat in polar materials. High intensity radio signals create molecular motion which causes the material to rise in temperature. When the temperature reaches the melt point of the material, the two surfaces will bond together.

Most known RF sealed packages in the market today are formed from polyvinyl chloride (PVC). PVC is inexpensive compared to other commodity packaging resins and it possesses good RF sealing properties. However, the packaging industry is attempting to eliminate PVC from packaging because PVC packaging material is perceived as being less environmentally friendly than other materials.

Semicrystalline polyethylene terephthalate (PET) polymers are disadvantaged in RF sealing applications because of their ability to crystallize at elevated temperatures. Amorphous polymers like PVC and glycolised polyester (PETG) have broad RF processing windows while semicrystalline PET materials have a somewhat narrow process window.

Previous methods of improving the RF sealability of polyester materials have been in the area of glycol modification. Some of these methods include PETG which is a copolymer formed from the polymerization of terephthalic acid and ethylene glycol with up to 50 mol % cyclohexane dimethanol (CHDM) replacing a portion of the ethylene glycol, PETG/PET/PETG coextruded structures, and PET blended with PETG. However, PETG materials cannot be recycled in traditional PET bottle recycle streams. It would be desirable to provide a thermoformable plastic material that is RF-sealable and recyclable in existing PET bottle recycle streams.

### BRIEF DESCRIPTION OF THE DISCLOSURE

In one aspect, a thermoformable packaging material is provided. The thermoformable packaging material includes a thermoplastic composition that includes a polyethylene terephthalate modified with an isophthalic acid co-monomer. The amount of isophthalic acid co-monomer used is sufficient to render the thermoplastic composition RF sealable.

In another aspect, a method of forming a packaging material is provided. The method includes providing a thermoplastic composition that includes a polyethylene terephthalate modified with an isophthalic acid co-monomer, the amount of isophthalic acid co-monomer used is sufficient to render the thermoplastic composition RF sealable. The method also includes extruding the thermoplastic composition to form a thermoformable, RF sealable sheet of packaging material.

### DETAILED DESCRIPTION OF THE DISCLOSURE

A RF sealable thermoplastic material formed from a isophthalic acid (IPA) modified PET copolymer is described below in detail. IPA replaces a portion of the terephthalic acid in the polymerization of PET to form a copolymer. The use of IPA as a co-monomer in PET packaging materials enables PET to be RF sealed without the addition of a glycol modifier. IPA modification of PET permits the material to process like an amorphous polymer while maintaining the advantages of a semicrystalline material. IPA modification of PET provides advantages for RF sealing applications, including, for example, (1) lower melt temperature than PET; (2) slower rate of crystallization than PET; (3) capability of recycling into traditional PET bottle recycle streams, where PETG and PVC cannot be recycled into these traditional recycle streams; and (4) provides greater stiffness which permits the use of lower thickness packaging. In addition, due to lower raw material cost, IPA modified PET can provide an economic advantage over CHDM modified PET materials (PETG).

In an exemplary embodiment, a thermoplastic packaging material is formed from a thermoformable, RF sealable, thermoplastic composition. The thermoformable, RF sealable, thermoplastic composition includes a polyethylene terephthalate copolymerized with an isophthalic acid co-monomer. The polyethylene terephthalate is modified by replacing a portion of the terephthalic acid monomer with from about 1.4 percent by weight to about 10 percent by weight of isophthalic acid co-monomer, the percent by weight based on the total weight of the thermoplastic composition. In another embodiment, the polyethylene terephthalate is modified by replacing a portion of the terephthalic acid monomer with from about 4 percent by weight to about 10 percent by weight of the isophthalic acid co-monomer, and in still another embodiment, polyethylene terephthalate is modified by replacing a portion of the terephthalic acid monomer with from about 6 percent by weight to about 10 percent by weight of the isophthalic acid co-monomer. Suitable IPA modified PET copolymers are commercially available from Invista, Inc., Charlotte, N.C., M & G. Polymers, LLC, Apple Grove W. Va., and Wellman, Inc., St. Louis, Mo.

It should be understood that as used herein, “formed from” denotes open, e.g., “comprising”, claim language. As such, it is intended that a composition “formed from” a list of components be a composition that includes at least these recited components, and can further include other, non-recited components, during the composition's formation, for example, UV absorbers; surfactants; processing aids, stabilizers, and the like.

The thermoplastic packaging material, in the exemplary embodiment, is a clear transparent material. In other embodiments, the thermoplastic packaging material is a colored transparent material, or a translucent material, with or without coloring. To achieve a colored packaging material, a colorant, for example, any suitable known pigment or dye, can be included in the thermoformable, RF sealable, thermoplastic composition, in a sufficient amount to produce the desired color and/or translucent density desired.

The thermoplastic packaging material, in the exemplary embodiment is formed by extruding a thermoformable, RF sealable, thermoplastic composition that includes a polyethylene terephthalate modified with from about 1.4 percent by weight to about 10 percent by weight of isophthalic acid co-monomer, using extrusion techniques, conditions, and equipment generally known in the art. For example, in one embodiment the extrusion may be carried out at temperatures of about 400° F. to about 600° F., and in another embodiment, from about 425° F. to about 500° F., and in another embodiment, from 425° F. to about 450° F. The thermoplastic composition is extruded through a die to form a sheet of packaging material. The extruded sheet material is passed through opposing calendar rolls to adjust the thickness of the extruded sheet material to between, for example, about 0.1 mm to about 1 mm, and in another embodiment, from about 0.5 mm to about 1 mm. The packaging material can be cut into individual sheets or rolled into a continuous sheet roll of packaging material. In another embodiment, the thermoplastic composition is extruded as a cap layer on to an extruded layer of PET.

To thermoform the thermoplastic packaging material, the thermoplastic packaging sheet material is heated to about 210° F. to about 300° F. and then the hot sheet is placed in a mold. The hot sheet is then thermoformed by any suitable thermoforming process generally known in the art, including, for example, vacuum forming, thermo-stamping, and compression molding. The thermoformed thermoplastic packaging material is cooled and cut to size.

The thermoformed packaging material, in one embodiment, includes first and second portions of a package. The first and second portions may be formed so as to be hinged together, if desired. The package is RF-sealed, along one or more adjacent edges of the first and second portions to retain an article disposed within the package. The article may be disposed within one or more containers, such as blisters, formed during formation of the first and second portions of the package. In another embodiment, the blisters may be separately formed pieces and are then sealed to a substrate, such as a sheet of coated card stock or a sheet of thermoplastic film. Alternatively, the package may be formed from a single, integral piece having two portions surrounding the article and sealed to itself. In another embodiment, the thermoformed packaging material described above can be sealed by a heat sealing process.

RF sealing is a dielectric sealing technique. RF sealing may include dielectric heating of multiple layers of thermoplastic material in order to melt and seal adjacent layers together. The electric current may be supplied by a pair of electrodes positioned in opposing relationship above and below the thermoplastic material to be sealed. The electrodes are powered by a radio frequency electrical signal.

The layers of thermoplastic material or thermoplastic film are positioned between the top and bottom electrodes. Typically, the top electrode is a metallic electrode formed in the shape of the desired sealing pattern and the bottom electrode formed as a metal platen of a pneumatically operated press. The electrodes are brought together in contact with the thermoplastic material. Upon contact, RF energy is applied to the electrodes and causes heating and softening or melting of the thermoplastic films in the region defined by the shape of the top electrode. The flow of RF energy heats the films by dielectric loss heating generated within the films until a seal is formed. The metallic electrode and metal platen do not become hot from the high frequency energy and instead draw heat from the material being sealed.

Once sufficient melting or softening of the films has occurred, the RF power to the electrodes is interrupted to allow for cooling and re-solidifying of the films in or near the region defined by the top electrode. Each electrode acts as a thermal heat sink for the heated films and re-solidifying under pressure provides a good seal. The electrodes are then separated and the sealed films are removed. Sealing thermoplastic film materials with electromagnetic energy at radio frequencies has the advantage of rapid cooling as compared to the longer cooling periods in heat sealing.

Without being held to any particular theory, IPA modification of PET is believed to reduce thermal crystallization rates during either heating from the glassy state as in heating a sheet of packaging material in the thermoforming process or cooling from the melt in the RF sealing process as compared to the crystallization rates of unmodified PET. The reduced crystallization rate of IPA modified PET raises the temperature of crystallization during heating and lowers the temperature of crystallization during cooling from the melt when compared to the temperature of crystallization of unmodified PET. These attributes permit packages to be thermoformed while maintaining clarity and RF welded that produce clear, haze free welds.

Levels of IPA greater than 1% in IPA modified PET can reduce levels of strain induced crystallization as compared to unmodified PET. Strain induced crystallization results in strain hardening behavior of the plastic sheet. Stain hardening can limit the depth of draw in thermoforming. Stain hardening behavior is sometimes observed at 5% and 10% IPA levels, but at progressively higher stretch ratios. Therefore, levels of IPA greater than 1% in IPA modified PET facilitate design flexibility in thermoformed parts. Table I below shows the effect of the amount of IPA in the IPA modified PET on glass transition temperature, crystallization temperature during heating, crystallization temperature during cooling, melt temperature, and crystallization half time measured at 150° C. Comparisons were made between unmodified PET and IPA modified PET, at IPA contents of 1%, 5%, and 10% by weight. The crystallization half time is defined as the time of isothermal heating at a given temperature (150° C.) that is required to attain 50% of the maximum possible crystallinity at the given temperature (150° C.).

TABLE I

| | Glass | Crystalli- | Crystalli- | | Crystallization |
|---|---|---|---|---|---|
| | Transition | zation | zation | Melt | Half Time @ |
| | Temp | Temp (° C.) | Temp (° C.) | Temp | 150° C. |
| % IPA | (° C.) | (Heating) | (Cooling) | (° C.) | (sec) |
| 0 | 76.7 | 144 | 187.5 | 249 | 27.6 |
| 1 | 75.8 | 145.7 | 181.3 | 247.1 | 24 |
| 5 | 75.1 | 150.1 | 160.6 | 237.3 | 38.4 |
| 10 | 74 | 164 | 146.5 | 225.1 | 69.6 |

As shown in Table I, IPA levels greater than 1% in IPA modified PET thermoplastic composition lowers the melt temperature of the plastic packaging material as compared to unmodified PET. The lower melt temperature facilitates the use of a heat sealing process at lower temperatures in addition to improved RF sealing.

The thermoformable, RF sealable, thermoplastic composition will be further described by reference to the following examples which are presented for the purpose of illustration only. Unless otherwise indicated, all amounts are listed as parts by weight.

### EXAMPLES

The RF sealed weld strengths of various IPA contents of modified PET compositions described above were compared to the weld strength of known PVC sheet packaging material. The IPA modified PET Examples I-IV contained 1.4%, 3.6%, 6.5% and 10% IPA levels in each IPA modified PET respectively. Comparative Example V contained 100% PVC, commercially available from Extec Plastics, Inc., Richmond, Ill. Test sample sheets were formed by extruding each of the test materials of Examples I-V at a temperature of about 485° F. The test sample sheets were then calendered to a thickness of about 0.5 mm.

All the RF welded test samples from Examples I-V were prepared using an RF bar seal die and all machine settings were kept constant for each example test sample. The weld strength was measured by determining the amount of force per square inch of weld it took to break the RF seal. The four IPA modified PET samples and the PVC sample were rated on a poor, good, and very good scale. Table II below, shows the compositions in parts by weight and the ratings of Examples I-V. Examples I-IV had superior weld strength when compared to comparative Example V.

TABLE II

| | I | II | III | IV | V |
|---|---|---|---|---|---|
| PET | 98.6 | 96.4 | 93.5 | 90.0 | 0 |
| IPA | 1.4 | 3.6 | 6.5 | 10.0 | 0 |
| PVC | 0 | 0 | 0 | 0 | 100 |
| Weld Test | Very | Very | Very | Very | Good |
| Rating | Good | Good | Good | Good | |

While the invention has been described in terms of various specific embodiments, those skilled in the art will recognize that the invention can be practiced with modification within the spirit and scope of the claims.

What is claimed is:

1. A thermoformable packaging material comprises:
a thermoplastic composition comprising a polyethylene terephthalate modified with an isophthalic acid co-monomer, the amount of isophthalic acid co-monomer sufficient to render said thermoplastic composition RF sealable.

2. A thermoformable packaging material in accordance with claim 1 wherein said polyethylene terephthalate is modified with from about 1.4 percent by weight to about 10 percent by weight of an isophthalic acid co-monomer, the percent by weight based on the total weight of said thermoplastic composition.

3. A thermoformable packaging material in accordance with claim 1 wherein said polyethylene terephthalate is modified with from about 4 percent by weight to about 10 percent by weight of an isophthalic acid co-monomer, the percent by weight based on the total weight of said thermoplastic composition.

4. A thermoformable packaging material in accordance with claim 1 wherein said polyethylene terephthalate is modified with from about 6 percent by weight to about 10 percent by weight of an isophthalic acid co-monomer, the percent by weight based on the total weight of said thermoplastic composition.

5. A thermoformable packaging material in accordance with claim 1 further comprising a colorant.

6. A method of forming a packaging material, said method comprising:
providing a thermoplastic composition comprising a polyethylene terephthalate modified with an isophthalic acid co-monomer, the amount of isophthalic acid co-monomer sufficient to render the thermoplastic composition RF sealable; and
extruding the thermoplastic composition to form a thermoformable sheet of packaging material.

7. A method in accordance with claim 6 further comprising thermoforming the sheet of packaging material into a predetermined shape.

8. A method in accordance with claim 7 wherein said thermoforming the sheet of packaging material into a predetermined shape comprises thermoforming the sheet of packaging material into two sections.

9. A method in accordance with claim 8 further comprising sealing, by radio frequency sealing, at least a portion of the first section to at least a portion of the second section.

10. A method in accordance with claim 6 wherein said providing a thermoplastic composition comprises providing a polyethylene terephthalate modified with from about 1.4 percent by weight to about 10 percent by weight of an isophthalic acid co-monomer, the percent by weight based on the total weight of the thermoplastic composition.

11. A method in accordance with claim 6 wherein said providing a thermoplastic composition comprises providing a polyethylene terephthalate modified with from about 4 percent by weight to about 10 percent by weight of an isophthalic acid co-monomer, the percent by weight based on the total weight of the thermoplastic composition.

12. A method in accordance with claim 6 wherein said providing a thermoplastic composition comprises providing a polyethylene terephthalate modified with from about 6 percent by weight to about 10 percent by weight of an isophthalic acid co-monomer, the percent by weight based on the total weight of the thermoplastic composition.

13. A method in accordance with claim 6 wherein providing a thermoplastic composition comprises providing a thermoplastic composition comprising a polyethylene terephthalate modified with an isophthalic acid co-monomer, and further comprising a colorant.

14. A method in accordance with claim 7 wherein said thermoforming the sheet of packaging material into a predetermined shape comprises thermoforming the sheet of packaging material into a blister sheet having a cavity therein.

15. A method in accordance with claim 14 further comprising sealing the blister to a sheet of coated card stock by RF sealing.

16. A method in accordance with claim 14 further comprising sealing the blister to a sheet of thermoplastic film by RF sealing.

17. A method in accordance with claim 7 wherein said thermoforming the sheet of packaging material into a predetermined shape comprises thermoforming the sheet of packaging material into a first portion and a second portion, at least one of the first and the second portion having a cavity therein.

18. A method in accordance with claim 17 further comprising sealing the first portion to the second portion by RF sealing.

19. A method in accordance with claim 6 wherein said extruding the thermoplastic composition comprises extruding the thermoplastic composition as a cap layer onto a layer of extruded PET to form a multi-layer thermoformable sheet of packaging material.
